(19) United States
(12) Patent Application Publication
(10) Pub. No.: US 2016/0032876 A1
(43) Pub. Date: Feb. 4, 2016

(54) Firing-paired Intake Manifold

(71) Applicant: Ted Hollinger, Algona, IA (US)

(72) Inventor: Ted Hollinger, Algona, IA (US)

(21) Appl. No.: 14/656,411

(22) Filed: Mar. 12, 2015

Related U.S. Application Data
(60) Provisional application No. 61/951,612, filed on Mar. 12, 2014.

(51) Int. Cl. F02M 35/10; F02B 43/10; F02M 35/104

(52) U.S. Cl. CPC F02M 35/10216; F02M 35/104; F02M 35/10288; F02M 35/1015; F02B 43/10

(57) ABSTRACT

The disclosed apparatus, systems and methods relate to an intake manifold for use in internal combustion engines which pairs cylinders together so as to allow the sharing of air and fuel to improve efficiency and power.

### CROSS-REFERENCE TO RELATED APPLICATION(S)

This application claims priority to U.S. Provisional Application No. 61/951,612, filed Mar. 12, 2014 and entitled “Firing-Paired Intake Manifold,” which is incorporated herein it its entirety.

### TECHNICAL FIELD

The disclosure relates to internal combustion engine devices, systems and methods. In certain embodiments, the disclosed intake manifold can relate to hydrogen-powered, gasoline powered, or diesel-powered engines.

### BACKGROUND

The presently disclosed apparatus relates to an engine intake manifold, and more particularly to an intake manifold for hydrogen engines.

Hydrogen is a renewable resource which presents one possible alternative fuel for reduction of greenhouse gas emissions. One such application is in improving the efficiency of internal combustion engines while running a clean mixture of hydrogen and oxygen. Hydrogen powered engines have very few emissions and operate much cleaner than engines powered by diesel, gasoline. or even natural gas. Studies have indicated that emissions are heat, nitrogen, and water and little else.

The use of traditional cylinder engines as hydrogen-powered engines present certain challenges, however.

### BRIEF SUMMARY

Discussed herein are various embodiments relating to a firing-paired intake manifold.

In Example 1, an intake manifold comprises at least one elongate pipe, further comprising a bifurcated first end adapted for providing fuel to two paired cylinders and a second end.

Example 2 relates to the intake manifold according to Example 1, further comprising a plenum.

Example 3 relates to the intake manifold according to Example 2, further comprising at least one injector.

Example 4 relates to the intake manifold according to Example 3, wherein the intake manifold is configured for use with a hydrogen engine.

Example 5 relates to the intake manifold according to Example 4, wherein the intake manifold is configured for use with a V8 engine.

Example 6 relates to an intake manifold system for use in power generation, comprising a four-stroke internal combustion engine comprising a plurality of combustion chambers fired in sequence, and an intake manifold in gaseous communication with the engine, the intake manifold further comprising at least one pipe comprising a first bifurcated end which comprises first and second combustion chamber attachment portions and a second end which extends substantially vertically above the chamber, wherein the first and second combustion chamber attachment portions are in sealed gaseous communication with one another and first and second paired combustion chambers.

Example 7 relates to the intake manifold according to Example 6, wherein the plurality of combustion chambers are fired at opposite points in the firing sequence.

Example 8 relates to the intake manifold according to Example 7, wherein the internal combustion engine further comprises a plurality of cylinders which can be positioned in top dead center and bottom dead center positions.

Example 9 relates to the intake manifold according to Example 8, wherein the first and second paired combustion chamber cylinders are in the same top dead center position.

While multiple embodiments are disclosed, still other embodiments of the disclosure will become apparent to those skilled in the art from the following detailed description, which shows and describes illustrative embodiments of the disclosed apparatus, systems and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a cross sectional schematic of a known V-style engine.

FIG. 2 is a top-view representative schematic overview of a typical cylinder pattern for a known V8 engine.

FIG. 3. depicts possible firing order patterns for a Ford V8 engine.

FIG. 4 is a front perspective view of an exemplary embodiment of the intake manifold.

FIG. 5 is a further perspective view of an alternate embodiment of the intake manifold.

FIG. 6 is a further perspective view of the manifold embodiment of FIG. 5.

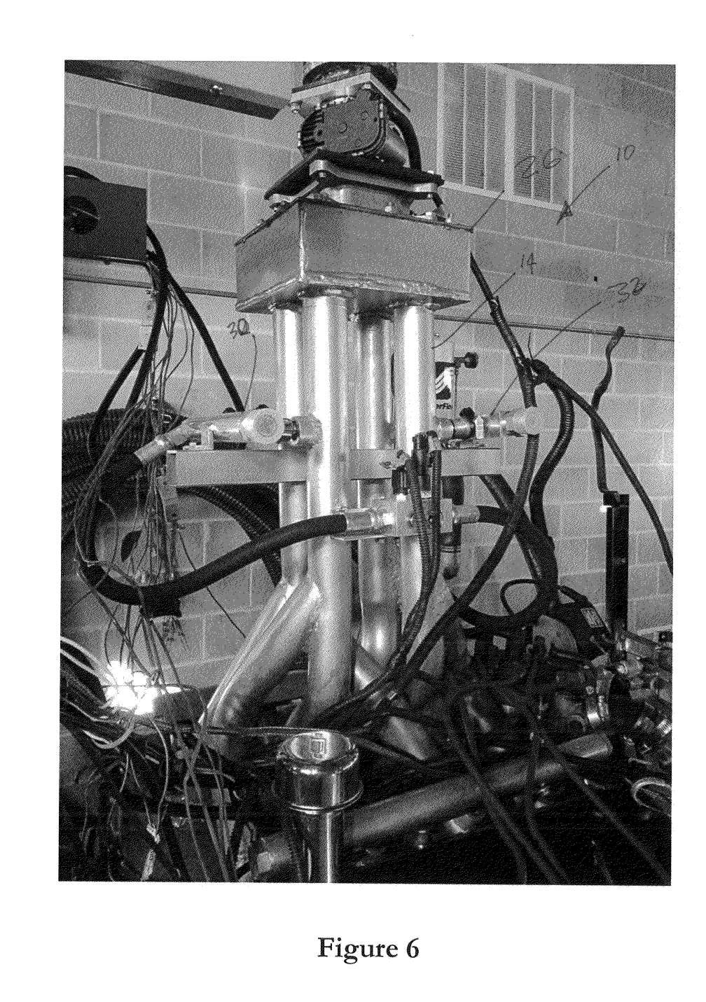

FIG. 7 is a further perspective view of the manifold embodiment of FIG. 5.

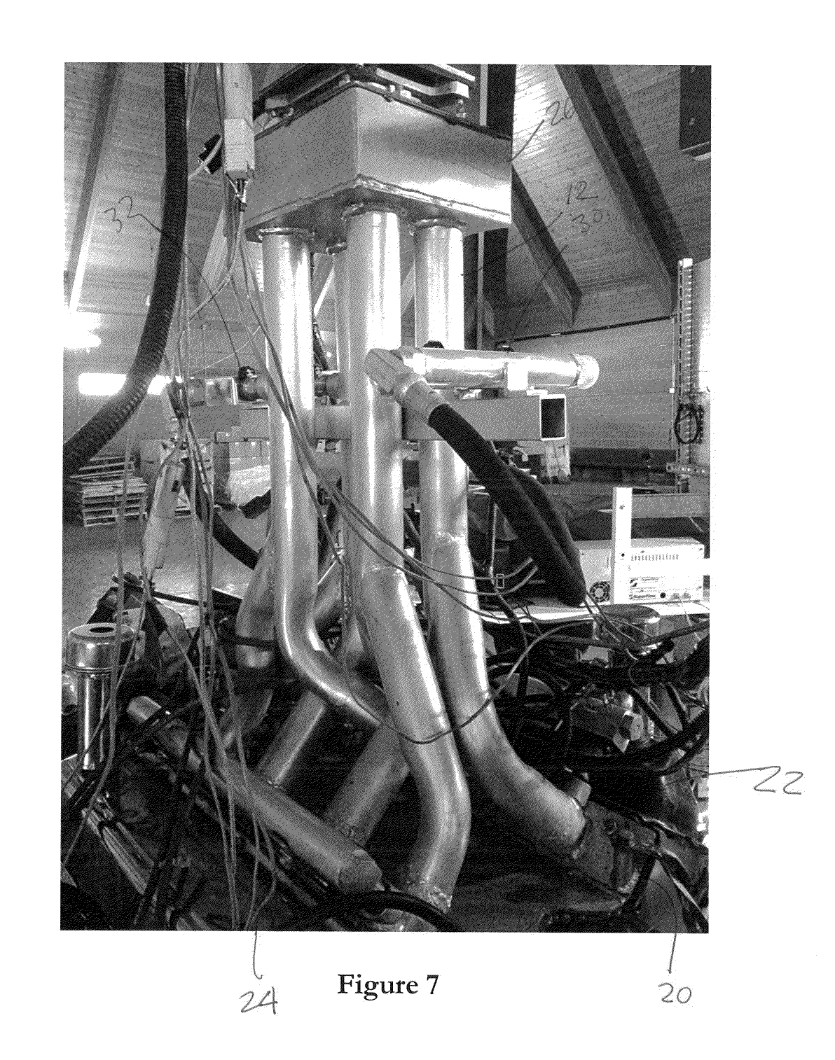

FIG. 8 depicts a diagram showing a model firing, cam, and injection schedule for a V8 engine with a 1-5-4-26-3-7-8 firing order.

FIG. 9 depicts a diagram showing a model firing, cam, and injection schedule for a V8 engine with a 1-5-4-2-6-3-7-8 firing order.

### DETAILED DESCRIPTION

The presently disclosed apparatus, systems and methods relate to various embodiments of an intake manifold adapted for use with internal combustion engines. For brevity, the various embodiments will be referred to collectively as a “manifold” or “intake manifold” though that is not intended to limit the disclosure to any specific modality.

As is known in the art, an intake manifold is utilized by most fuel-powered engines to introduce the fuel/air mixture into the engine cylinders to distribute the fuel/air to each intake port and/or cylinder head. However, the traditional prior art manifolds present certain problems for internal combustion engines based on the physical configuration of the cylinders and the limited number of possible firing orders, which inhibits the efficiency of the engine because various cylinders are competing with one another for air. The presently disclosed intake manifold addresses these limitations to optimize the efficiency and performance of the engine. While the discussion of this disclosure focuses on the use of hydrogen as a fuel, this manifold has applications in a variety of other internal combustion engines, as would be apparent to one of skill in the art. Certain modifications inherent to the various fuels (gasoline, diesel, natural gas and the like) are thereby contemplated. For example, the height of the manifold pipes could be markedly lower in a gasoline powered engine, as it would not present the same buoyancy challenges. Further, the disclosed gaseous seals may also be fluid seals.

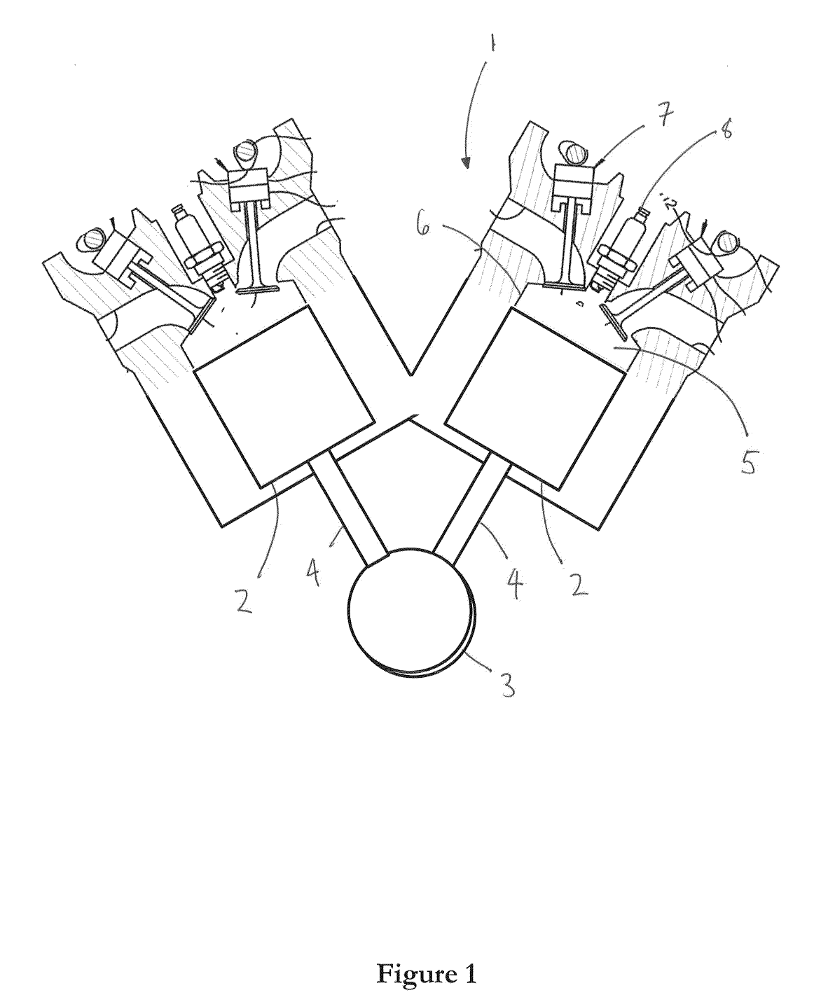

FIG. 1 depicts a typical known engine 1 has a number of pistons 2, which are connect to the crankshaft 3 by way of rods 4. A combustion chamber 5 is formed at the between the piston 2 and cylinder head 6, where the fuel is let in by way of the valve 7, ignited by the sparkplug 8 to drive the piston down on the rod 4 and drive the crankshaft 3, thereby converting the linear power of the moving pistons into radial power output. Critically for purposes of the manifold, in a four-stroke engine the piston 2 goes through two “up” and two “down” strokes per firing cycle, such that intake happens exactly once.

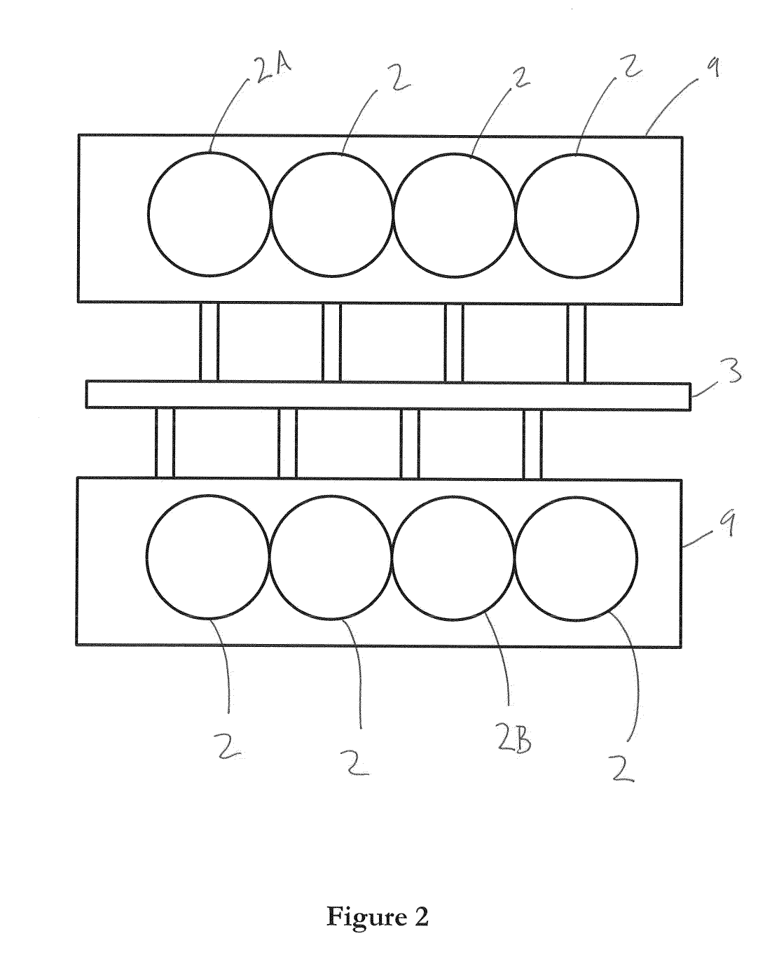

As is shown in FIG. 2, and as is also well-known in the art, the pistons 2 are arranged in the cylinder block 9. In individual arrangements of two or more cylinders there is a also a firing order, wherein the various pistons 2 are fired in a specific sequence to drive the crankshaft 3. Different engines manufactured by various companies have distinct firing orders, and these are understood and well established in the art.

As would be apparent to one of skill in the art, in certain applications a variety of firing order combinations can be used, depending on the type of underlying engine, as discussed herein. For example, in certain embodiments the firing order can be set to 1-5-4-2-6-3-7-8 and each number in the firing order is 90 degrees apart from the adjacent numbers, therefore 1 & 6 are 360 degrees apart as are 5 & 3, 4 & 7 and 2 & 8. However, this presents a challenge wherein using a prior art single-plane or two-plane intake manifold, as the 7th and 8th cylinders are set 90 degrees from one another and yet will attempt to draw air in sequence.

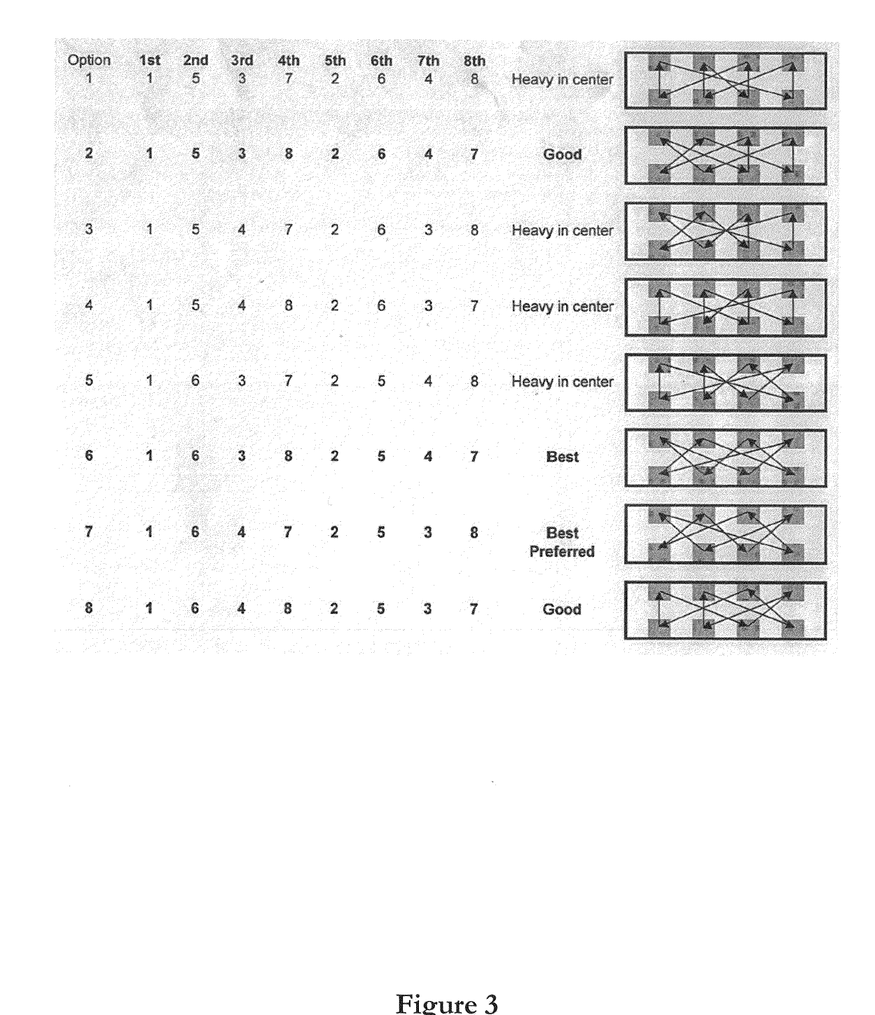

It is important to note that it is possible to nearly balance the crankshaft in certain configurations, but no configuration of the pistons in a V6 or V8 engine results in a situation in which two of the pistons are not competing for air with one another. Accordingly, there is no practical, functional crankshaft configuration such that there are not cylinders firing next to one another both in order and in proximity, which can cause those cylinders to be less efficient as they are competing with one another. As is depicted in FIG. 3, various firing patterns which can be used in an engine to attempt to balance and otherwise improve the function of the engine. Because of airflow considerations, certain orders are preferred. However, all circumstances result in a set of cylinders in proximity which are firing next to one another and are competing for air with one another from a prior art manifold. The presently disclosed intake manifold addresses the issue, such that there is no competition for air, and also allows for increased efficiency because fuel which is not utilized by a first paired cylinder can be quickly and easily utilized by the second paired cylinder.

In certain exemplary embodiments, the intake manifold functions to pair cylinders which are in the same crankshaft position but opposite in the firing order in the same intake pipe so as to address some of the challenges present in hydrogen engines. Rather than addressing the balance problem by way of the firing order, physical and crankshaft organization, the present manifold seeks to balance the engine by delivering air to pairs of the cylinders at differing locations by pairing the cylinders. The critical aspect for purposes of the manifold is that in certain of these configurations, such as in the case of a typical V8 engine, individual pistons are paired such that the first cylinder 2A and second cylinder 2B are in identical dead center positions on the crankshaft rotation but are firing at opposing times. Meaning, while the first cylinder 2A is in the intake phase, the other cylinder 2B is in the exhaust phase, and vice versa. Accordingly, only one of these paired pistons has an open valve at any given time.

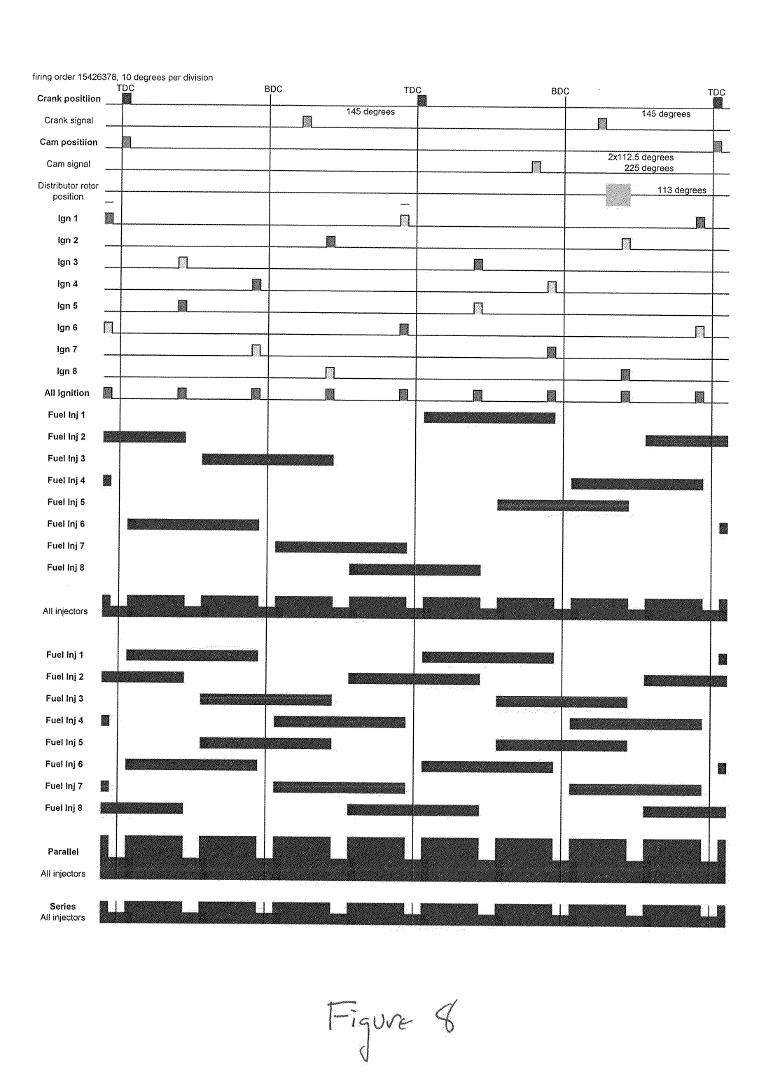

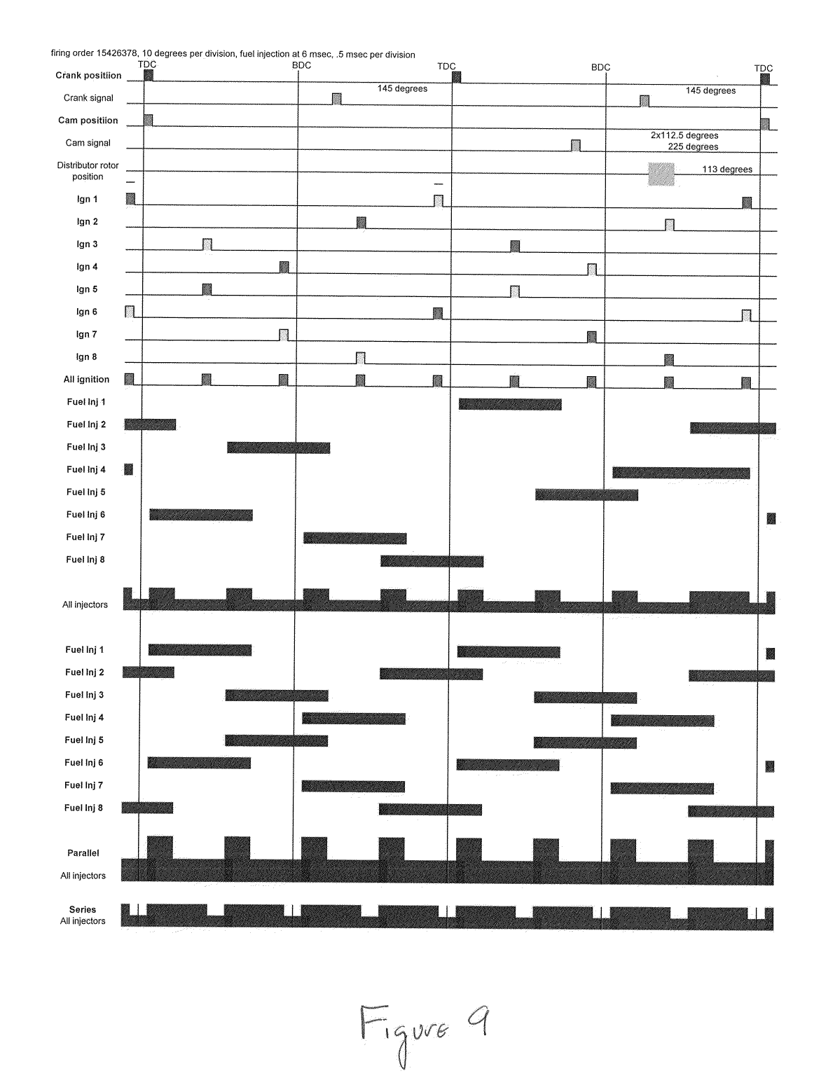

Hydrogen has a very high flame velocity and is very easily ignited. The ignition of hydrogen and air can occur with very little energy and/or at relatively low temperatures. Hydrogen's Lower Explosion Limit (LEL) is only 4%. Accordingly, it is imperative in a hydrogen-powered engine that it be delivered to the combustion chamber after the exhaust valve is closed and shortly after the intake valve is opened (as is described in detail in relation to FIGS. 1-2). Hydrogen engines are almost always sequentially port injected. This means that the fuel injection system is synchronized to the camshaft position (as is depicted in reference to FIGS. 8-9) to optimize the efficiency of the engine. In applications using various alternative fuels, adjustments can be made that would be apparent to one of skill in the art. The critical issue is the pairing of the cylinders of a V6 or V8 engine, for example, such that the fuel and air are drawn from a single pipe.

The outcome of this combustion chamber pairing is that the valves for these cylinders will never be open at the same time, thus combustion cannot happen on the wrong cylinder despite fueling two cylinders simultaneously. Further, the height of the pipes and the buoyancy of hydrogen result in excess hydrogen which may be left in the pipe rising away from the hot exhaust, which prevents pre-ignition and backfiring. Finally, the pairing of two cylinders with a single pipe results in a balancing of the firing of each cylinder, as any excess hydrogen left in the manifold can be utilized by another cylinder in the firing order rapidly, before it is able to reach the plenum. This results in a more efficient and powerful engine.

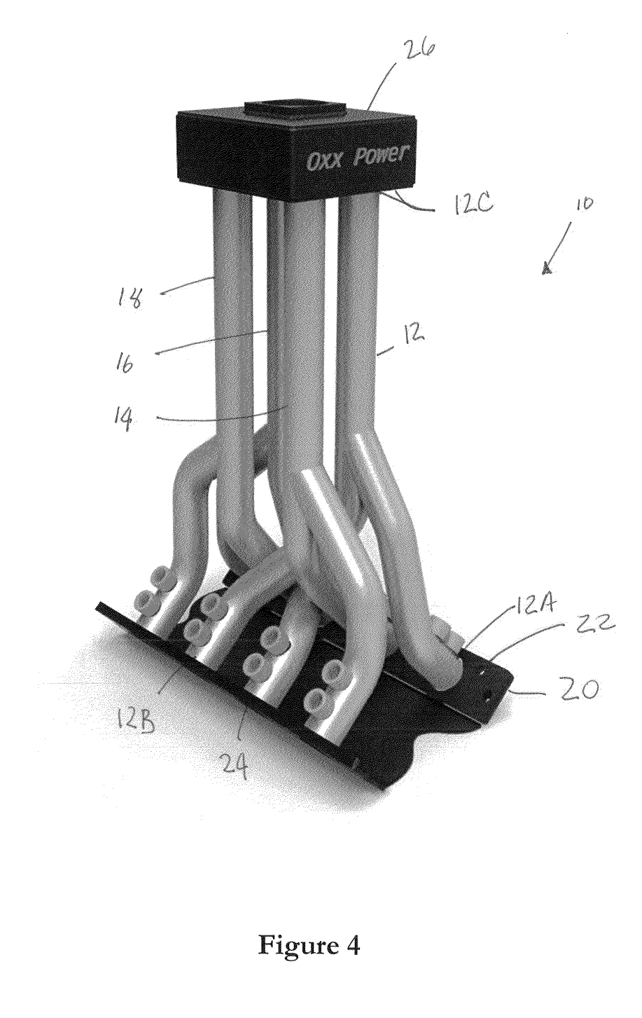

Turning to exemplary embodiments of the manifold 10 in detail, and as depicted for in FIG. 4, certain embodiments make use of the engine's firing order pairing to provide the fuel and air to each combustion chamber in an improved manner, so as to address novel issues inherent in the use of this fuel. In certain embodiments, the manifold 10 comprises at least one hollow elongate shaft, or pipe 12, 14, 16, 18 extending above the cylinder head 20. In exemplary embodiments, each pipe 12 has a first bifurcated end which divides into first 12A and second 12B combustion chamber attachment portions, which accordingly are in gaseous communication with two paired cylinders (as described above) at the respective cylinder heads 22, 24. Each pipe also has a second end 12C is in sealed gaseous communication with the plenum 26, which houses the throttle body. In certain embodiments, the fuel injectors are disposed at the first end, and the timing of the injectors is controlled such that the cam shaft is controlled, as would be apparent to one of skill in the art.

Accordingly, a single pipe 12 is able to provide fuel to both paired cylinders simultaneously. However, because only one of the cylinders will be in the intake/firing phase at any given time, only that cylinder will draw fuel from the manifold 10 at that moment, while the other will not. In these configurations, a first cylinder is thereby in the intake phase while the paired cylinder is in the power phase, thus both are moving in concert.

Further, the minimum height of the tube is based upon on how high hydrogen will rise between valves opening and closing in each pipe depending on the speed desired and the known buoyancy of hydrogen. For example, in an engine designed to run steadily at higher RPM, a lower pipe length is required.

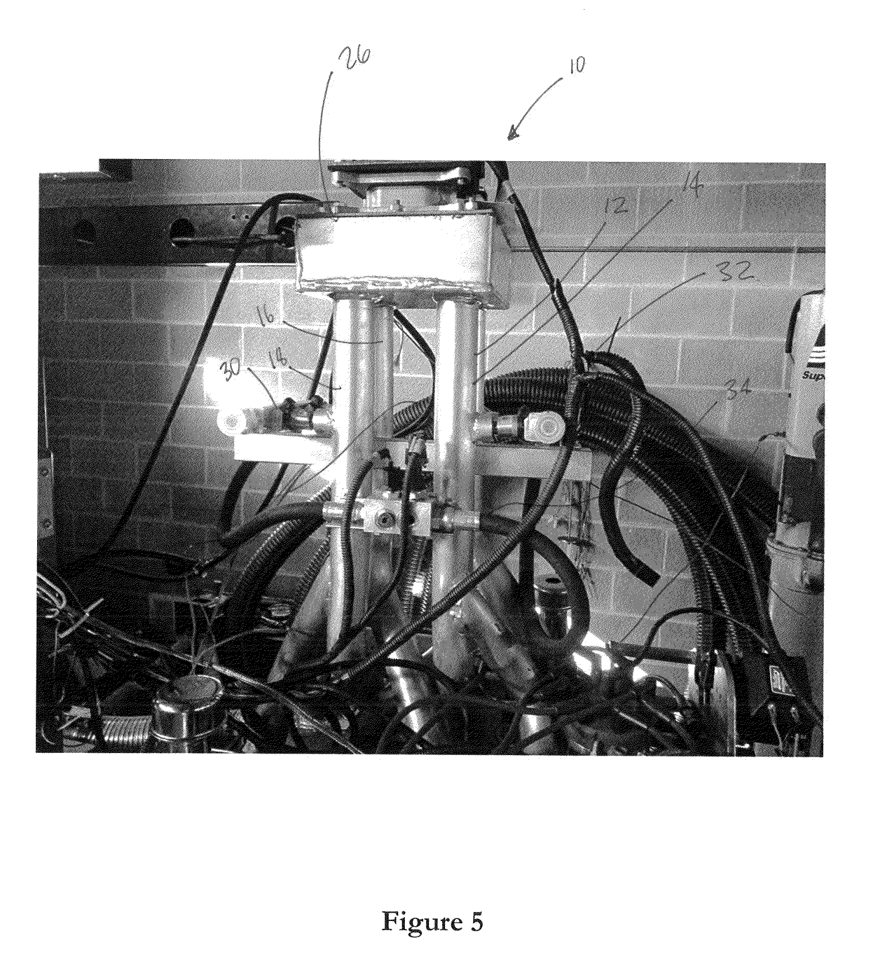

As is shown in FIG. 5, in certain exemplary embodiments of the manifold 10 further comprises a second set of fuel rails 30, 32, 34, 36 in communication with each pipe 12, 14, 16, 18. This embodiment allows the use of one injector per paired cylinder set, and as there are two cylinders fed by each pipe, the total number of required injectors is halved. In alternate embodiments, the injectors remain at the first end of the pipe near the first 12A and second 12B combustion chamber attachment portions, as described above.

As discussed, because hydrogen is extremely light, it rapidly rises in the tubes 12, 14, 16, 18. In exemplary embodiments of the manifold, the total internal volume of any given tube 12 will be less than the maximum volume of the combustion chamber, such that all of the hydrogen in the tube will ideally be taken in, or “swiped,” by the combustion chamber, so as to prevent backfires and pre-ignitions. In exemplary embodiments, all of the pipe hydrogen on each injection is completely vacated into the open valve and cylinder so that the hot closed valve does not come in contact with any remaining hydrogen and ignite it. However, in certain circumstances and at higher RPMs, some hydrogen may be left in the pipe due to a variety of factors, and the valve timing. Accordingly, another advantage of the present intake manifold is that excess hydrogen left in the pipe is available to be swiped by the paired cylinder, thus balancing the firing of the engine and resulting in greater efficiency and power, as is shown in relation to Tables 2-8. In exemplary embodiments, each cylinder will have substantially the same amount of air and fuel and all cylinders will be balanced, with the exhaust temperatures of each cylinders being much the same. Since the same amount of fuel and air is present in each cylinder, the same amount of power is produced by each cylinder. As a result, there is a constant amount of pressure produced with equal amounts of pressure being transferred to the crankshaft. This creates a smooth running motor and prevents any engine wobble.

The manifold can improve the amount of power produced by an internal combustion engine, particularly when using a gaseous fuel such as hydrogen. The increased production of power can be expected in engines with an even number of cylinders, (engines with more than two cylinders). The new device was developed to stop engines from backfiring when hydrogen was used as a fuel. The device reduces the number of injectors that are necessary and insures that cylinders are not competing for air. Each cylinder receives the same amount of air and makes it possible for each cylinder to achieve equal amounts of power, applying equal amounts of torque to the crankshaft, allowing the engine to run more smoothly generating more power. In exemplary embodiments, a cam sensor is not needed, as only one value is open at one time and hydrogen is injected in both sides simultaneously.

Returning to the exemplary embodiments of the intake manifold, Table 1 depicts multiple identical runs measuring standard temperature and pressure power and torque readings from a 9.4 L V8 engine running a equivalence ratio of approximately 0.41 hydrogen/oxygen fuel mixture (which is approximately 2.5 times the oxygen required for complete combustion) at approximately 3,600 rpm. The data on the left was gathered using a standard intake manifold, while the data on the right was collected using one embodiment of the disclosed intake manifold. As is apparent, the use of the intake manifold greatly increases the power of the engine as measured in horsepower and torque.

TABLE 1
Standard Corrected Power in Standard Hydrogen Engine
(Left) & Engine Running with Intake Manifold (Right)

| | EngSpd | STPPwr | STPTrq | EngSpd | STPPwr | STPTrq |
|---|---|---|---|---|---|---|
| | RPM | CHp | Clb-ft | RPM | CHp | Clb-ft |
| | 3,605 | 124.9 | 181.9 | 3,663 | 211.5 | 303.3 |
| | 3,633 | 127.9 | 185.0 | 3,639 | 228.8 | 330.3 |
| | 3,587 | 124.0 | 181.6 | 3,604 | 254.1 | 370.2 |
| | 3,604 | 124.9 | 182.0 | 3,624 | 262.5 | 380.4 |
| | | | | 3,596 | 267.8 | 391.2 |
| AVG | 3,607 | 125 | 183 | 3,625 | 245 | 355 |
| STDEV | 19.05037 | 1.703673 | 1.59243 | 27.03146 | 23.94563 | 36.97833 |

Tables 2-3 depict several runs measuring power and torque readings from a 9.4 L V8 engine running a 0.41 equivalence ratio hydrogen/oxygen fuel mixture at approximately 3,600 rpm. Getting the same equivalence ratio in each combustion chamber increases the power. These tables also depict the exhaust temperatures taken from two of the cylinders (labeled “Exh 1” and “Exh 2”). The data in Table 2 was gathered using a standard intake manifold, while the data in Table 3 was collected using one embodiment of the disclosed intake manifold. Again, use of the intake manifold increased the power and torque of the engine, with all other conditions remaining constant. The averages and standard deviations are also given.

TABLE 2
Measured Torque and Power in Standard Hydrogen Engine

| EngSpd | EngPwr | EngTrq | STPPwr | STPTrq | Exh 1 | Exh 2 |
|---|---|---|---|---|---|---|
| RPM | Hp | lbs-ft | CHp | Clb-ft | deg F. | deg F. |
| 3,605 | 109.0 | 158.8 | 124.9 | 181.9 | 1,115 | 919 |
| 3,633 | 111.7 | 161.5 | 127.9 | 185.0 | 1,112 | 960 |
| 3,587 | 107.5 | 157.4 | 124.0 | 181.6 | 1,086 | 935 |
| 3,604 | 108.2 | 157.8 | 124.9 | 182.0 | 1,091 | 971 |

TABLE 3
Measured Torque and Power in Hydrogen
Engine with Intake Manifold

| EngSpd | EngPwr | EngTrq | STPPwr | STPTrq | Exh 1 | Exh 2 |
|---|---|---|---|---|---|---|
| RPM | Hp | lbs-ft | CHp | Clb-ft | deg F. | deg F. |
| 3,663 | 183.3 | 262.9 | 211.5 | 303.3 | 1,022 | 992 |
| 3,639 | 199.1 | 287.4 | 228.8 | 330.3 | 1,066 | 1,045 |
| 3,604 | 222.0 | 323.5 | 254.1 | 370.2 | 1,125 | 1,123 |
| 3,624 | 229.6 | 332.7 | 262.5 | 380.4 | 1,164 | 1,171 |
| 3,596 | 234.5 | 342.5 | 267.8 | 391.2 | 1,211 | 1,233 |
| 3,534** | 232.6 | 345.7 | 265.5 | 394.6 | 1,239 | 1,273 |

**denotes short run

Tables 4-5 depict several runs measuring exhaust temperatures from a 9.4 L V8 engine running a 0.41 equivalence ratio hydrogen/oxygen fuel mixture at approximately 3,600 rpm. The data in Table 4 was gathered using a standard intake manifold, while the data in Table 5 was collected using one embodiment of the disclosed intake manifold. As is apparent, in addition to the increase in power, the exhaust temperatures between the cylinders have been balanced (as measured in Fahrenheit). Specifically, for example, the temperatures of cylinders 2 and 6 have increased with use of the manifold, thus indicating more balanced fuel consumption.

TABLE 5
Measured Exhaust Temperatures in Standard Hydrogen Engine

| | EngSpd | Exh 1 | Exh 2 | Exh 3 | Exh 4 | Exh 5 | Exh 6 | Exh 7 | Exh 8 |
|---|---|---|---|---|---|---|---|---|---|
| | RPM | deg F. | deg F. | deg F. | deg F. | deg F. | deg F. | deg F. | deg F. |
| | 3,605 | 1,115 | 919 | 991 | 1,145 | 1,035 | 920 | 983 | 1079 |
| | 3,633 | 1,112 | 960 | 1,031 | 1,168 | 1,064 | 950 | 1,020 | 1,111 |
| | 3,587 | 1,086 | 935 | 989 | 1,100 | 1,007 | 923 | 982 | 1,051 |
| | 3,604 | 1,091 | 971 | 1,020 | 1,114 | 1,030 | 929 | 1,019 | 1,074 |
| AVG | 3,607 | 1,101 | 946 | 1,008 | 1,132 | 1,034 | 931 | 1,001 | 1,079 |
| STDEV | 19.05 | 14.63 | 23.6 | 20.998 | 30.62 | 23.42 | 13.53 | 21.37 | 24.72 |

TABLE 6
Measured Exhaust Temperatures in Hydrogen Engine with Intake Manifold

| | EngSpd | Exh 1 | Exh 2 | Exh 3 | Exh 4 | Exh 5 | Exh 6 | Exh 7 | Exh 8 |
|---|---|---|---|---|---|---|---|---|---|
| | RPM | deg F. | deg F. | deg F. | deg F. | deg F. | deg F. | deg F. | deg F. |
| | 3,601** | 913 | 855 | 837 | 913 | 945 | 875 | 841 | 904 |
| | 3,663 | 1,022 | 992 | 927 | 1,016 | 1,047 | 990 | 952 | 1,033 |
| | 3,639 | 1,066 | 1,045 | 973 | 1,056 | 1,087 | 1,037 | 1,000 | 1,083 |
| | 3,604 | 1,125 | 1,123 | 1,045 | 1,113 | 1,139 | 1,106 | 1,069 | 1,148 |
| | 3,624 | 1,164 | 1,171 | 1,092 | 1,150 | 1,173 | 1,146 | 1,113 | 1,186 |
| | 3,596 | 1,211 | 1,233 | 1,156 | 1,197 | 1,215 | 1,195 | 1,171 | 1,234 |
| | 3,534** | 1,239 | 1,273 | 1,200 | 1,228 | 1,247 | 1,227 | 1,211 | 1,264 |
| AVG | 3,609 | 1,106 | 1,099 | 1,033 | 1,096 | 1,122 | 1,082 | 1,051 | 1,122 |
| STDEV | 40.668 | 114.3 | 146 | 129.03 | 109.79 | 104.4 | 123.7 | 129.53 | 125.5 |

TABLE 7
Tuned Standard Corrected Power and Exhaust Temperature
in a Hydrogen Engine with the Intake Manifold

| EngSpd | STPPwr | STPTrq | Exh 1 | Exh 2 | Exh 3 |
|---|---|---|---|---|---|
| RPM | CHp | lbs-ft | deg F. | deg F. | deg F. |
| 3,617 | 307.4 | 446.4 | 1,221 | 1,222 | 1,199 |
| 3,427 | 289.0 | 442.9 | 1,299 | 1,297 | 1,282 |

| Exh 4 | Exh 5 | Exh 6 | Exh 7 | Exh 8 |
|---|---|---|---|---|
| deg F. | deg F. | deg F. | deg F. | deg F. |
| 1,223 | 1,209 | 1,234 | 1,210 | 1,236 |
| 1,301 | 1,290 | 1,307 | 1,288 | 1,315 |

Accordingly, by using the presently disclosed intake manifold, the power of the engine is increased, and each cylinder is running more efficiently than in versions without the intake manifold, as is demonstrated by the consistent temperatures across the various cylinders. Thus, the intake manifold solves the competition problem and allows the engine to run more efficiently, as the excess hydrogen can be transferred between the paired cylinders.

In certain implementations, the timing of the firing can be tuned to attempt to increase the efficiency of the engine. It is known that in certain configurations of the V8 engine, for example, certain of the cylinders are less efficient than others, due to the overall distance that the fuel must travel, or a variety of other physical constraints. FIGS. 8-9 depict an exemplary firing order and timing pattern, wherein the valves are calibrated to allow precise fuel intake and maximize efficiency. In both FIGS. 8-9, the firing order is 1-5-4-2-6-3-7-8, but the timing is adjusted such that in FIG. 8 is set for running at 3,600 rpm, while in FIG. 9, the injector firing is shortened for optimization of firing in at 3,000 rpm, such that the firing occurs at approximately 0.5 ms after TDC and ceases approximately 2.5 ms before BDC, as opposed to ceasing 0.5 ms before BDC (as in FIG. 8). As is apparent to one of skill in the art, at 3,600 rpm, the engine is therefore being exposed to more hydrogen, which can be utilized by either of the paired cylinders, which balances the utilization and increases the power.

This cam timing is critical, so as to keep the engine calibrated for running at any particular speed for extended duration, such as in power generation applications. Because of the speed of the rotation, and the availability of hydrogen in the pipe, the manifold can thus be calibrated by one of skill in the art to accomplish this increased power input with the same amount of fuel using these techniques. As a result, a hydrogen-powered engine which is properly tuned and utilizing the present intake manifold is capable of producing at least an 8% greater power output than an equivalent gasoline-powered engine.

To help cool the combustion chamber (or cylinder) most engines will open the intake valve just Before Top Dead Center (BTDC) and hold the exhaust valve open slightly after TDC. This allows air to pass from the intake manifold across the piston and out the exhaust valve thus expelling exhaust gases and cooling the combustion chamber. It is absolutely critical that a hydrogen/air mixture, above the LEL, does not enter the combustion chamber while the intake and exhaust valves are both open. This means that the fuel injector cannot be pulsed open until the exhaust valve is closed and it must be closed before the piston reaches Bottom Dead Center (BDC). This design restriction causes the most concern at higher speeds and/or higher load conditions. Under these conditions, the fuel injectors have the least amount of time to deliver fuel and at the same time they must remain open longer because of the need to deliver more fuel for higher power. If the pulse width is too wide and hydrogen is left in the intake manifold then a violent explosion can occur (and usually does) the next time an intake valve opens and the hot exhaust valve can be seen by the air/fuel mixture.

The second problem with hydrogen is that its flame velocity can vary widely. Very lean mixtures (meaning larger oxygen-to-hydrogen ratios) burn slower and require more advanced valve timing. If the timing is too far advanced then pre-ignition occurs, which is similar to engine knocking in gasoline engines. If the air to a given cylinder is restricted slightly and the air/fuel mixture becomes richer than the flame velocity increases and the timing must be retarded. It is important that every cylinder have the same air/fuel ratio and thus the same ignition timing. These conditions are difficult for a V8 engine running hydrogen with traditional intake manifold designs. The solution has to be either an individual throttle control and fuel injector for each cylinder or a four plane firing order paired intake as described presently.

As is apparent to one of skill in the art, the presently described intake manifold increases the balance and power of an engine, such as a hydrogen-powered engine. Although the disclosure has been described with reference to preferred embodiments, persons skilled in the art will recognize that changes may be made in form and detail without departing from the spirit and scope of the disclosed apparatus, systems and methods.

What is claimed is:

1. An intake manifold comprising:
a. at least one elongate pipe, further comprising a bifurcated first end adapted for providing fuel to two paired cylinders and a second end.

2. The intake manifold of claim 1, further comprising a plenum.

3. The intake manifold of claim 2, further comprising at least one injector.

4. The intake manifold of claim 3, wherein the intake manifold is configured for use with a hydrogen engine.

5. The intake manifold claim 4, wherein the intake manifold is configured for use with a V8 engine.

6. An intake manifold system for use in power generation, comprising:
a. a four-stroke internal combustion engine comprising a plurality of combustion chambers fired in sequence; and
b. an intake manifold in gaseous communication with the engine, the intake manifold further comprising at least one pipe comprising a first bifurcated end which comprises first and second combustion chamber attachment portions and a second end which extends substantially vertically above the chamber; wherein the first and second combustion chamber attachment portions are in sealed gaseous communication with one another and first and second paired combustion chambers.

7. The intake manifold system of claim 6, wherein the plurality of combustion chambers are fired at opposite points in the firing sequence.

8. The intake manifold system of claim 7, wherein the internal combustion engine further comprises a plurality of cylinders which can be positioned in top dead center and bottom dead center positions.

9. The intake manifold of claim 8, wherein the first and second paired combustion chamber cylinders are in the same dead center position.
